(19) United States
(12) Patent Application Publication
(10) Pub. No.: US 2025/0253410 A1
(43) Pub. Date: Aug. 7, 2025

(54) ELECTRODE STACK AND BATTERY

(71) Applicant: TOYOTA JIDOSHA KABUSHIKI KAISHA, Aichi-ken (JP)

(72) Inventor: Akio MITSUI, Anjo-shi (JP)

(21) Appl. No.: 19/038,709

(22) Filed: Jan. 28, 2025

(30) Foreign Application Priority Data
Feb. 7, 2024 (JP) 2024-017173

(51) Int. Cl. H01M 10/0585

(52) U.S. Cl. CPC H01M 10/0585

(57) ABSTRACT

The present disclosure provides an electrode stack with a protective member disposed on a side section, which is resistant to peeling, as well as a battery comprising the electrode stack which is resistant to interference between the collector terminal and protective member and also has satisfactory structural efficiency. The electrode stack 10 of the disclosure is formed by stacking a plurality of preliminary electrode stacks 10′. The locations of the third and/or fourth side sections of those do not mutually match in the in-plane direction of the electrode stack, (i) the protective member 20 extends at least partway between the third side section of the innermost preliminary electrode stack and the third side section of the outermost thereof, and/or (ii) the protective member extends at least partway between the fourth side section of the innermost preliminary electrode stack and the fourth side section of the outermost thereof.

### FIELD

The present disclosure relates to an electrode stack and a battery.

### BACKGROUND

Batteries with laminate films are known which have a rectangular electrode stack, a collector terminal disposed on a pair of opposite side sections of the electrode stack, and a laminate film sealing the electrode stack together with the collector terminal, as disclosed in PTL 1.

One technique used for this type of battery, as disclosed in PTL 2, is to provide a protective member including a curable resin, on a side section where the collector terminal of the electrode stack is not disposed, in order to protect the side sections of the electrode stack.

### CITATION LIST

### Patent Literature

[PTL 1] Japanese Unexamined Patent Publication No. 2022-120699
[PTL 2] Japanese Unexamined Patent Publication No. 2021-114374

### SUMMARY

### Technical Problem

A protective member including a curable resin may peel from the electrode stack, resulting in failure to adequately exhibit its function as a protective member.

In order to solve this problem, it has been considered to more firmly anchor the electrode stack with the protective member, by extending the protective member up to the side section of the electrode stack where the collector terminal is disposed.

However, extending the protective member up to the side section of the electrode stack where the collector terminal is disposed may result in interference between the collector terminal and protective member. In order to help reduce such interference, it is necessary to provide excess space between the collector terminal and protective member, but this reduces the structural efficiency of the battery.

It is an object of the present disclosure to provide an electrode stack with a protective member disposed on a side section, which is resistant to peeling, as well as a battery comprising the electrode stack which is resistant to interference between the collector terminal and protective member and also has satisfactory structural efficiency.

### Solution to Problem

The present inventors have found that this object can be achieved by the following means.

### Aspect 1

An electrode stack which is rectangular and comprises a first side section where a protective member including a curable resin is disposed and a second side section opposite the first side section, and a third side section and a fourth side section opposite the third side section,
wherein the electrode stack is formed by stacking a plurality of preliminary electrode stacks,
   wherein the locations of the third and/or fourth side sections of the plurality of preliminary electrode stacks do not mutually match in the in-plane direction of the electrode stacks,
   wherein (i) the protective member extends at least partway between the third side section of the innermost preliminary electrode stack and the third side section of the outermost preliminary electrode stack, and/or
   wherein (ii) the protective member extends at least partway between the fourth side section of the innermost preliminary electrode stack and the fourth side section of the outermost preliminary electrode stack.

### Aspect 2

The electrode stack according to aspect 1, wherein:
the protective member extends only partway between the third side section of the innermost preliminary electrode stack and the third side section of the outermost preliminary electrode stack, and/or,
the protective member extends only partway between the fourth side section of the innermost preliminary electrode stack and the fourth side section of the outermost preliminary electrode stack.

### Aspect 3

The electrode stack according to aspect 1 or 2, wherein:
the distance between the third side section of the innermost preliminary electrode stack and the third side section of the outermost preliminary electrode stack is 0.5 mm or more and 2.0 mm or less, and/or,
the distance between the fourth side section of the innermost preliminary electrode stack and the fourth side section of the outermost preliminary electrode stack is 0.5 mm or more and 2.0 mm or less.

### Aspect 4

A battery comprising:
an electrode stack according to any one of aspects 1 to 3,
collector terminals disposed on the third and fourth side sections of the electrode stack, and
a laminate film sealing the electrode stack together with the collector terminals.

### Advantageous Effects of Invention

According to the disclosure it is possible to provide an electrode stack with a protective member disposed on a side section, which is resistant to peeling, as well as a battery comprising the electrode stack which is resistant to interference between the collector terminals and protective member and also has satisfactory structural efficiency.

### BRIEF DESCRIPTION OF DRAWINGS

FIG. 1 shows a schematic plan view as an example of an electrode stack of the disclosure as seen from above in the stacking direction (top side), and a schematic plan view as an example of an electrode stack of the disclosure as seen from below in the stacking direction (bottom side).

FIG. 2 shows a schematic plan view as an example of an electrode stack of a comparative example as seen from above in the stacking direction (top side), and a schematic plan view as an example of an electrode stack of a comparative example as seen from below in the stacking direction (bottom side).

FIG. 3 is a simplified cross-sectional view showing an example of an electrode stack of the disclosure.

FIG. 4 shows a schematic plan view as an example of a battery of the disclosure as seen from above in the stacking direction of the electrode stack (top side), and a schematic plan view as an example of a battery of the disclosure as seen from below in the stacking direction of the electrode stack (bottom side).

FIG. 5 shows a schematic plan view as an example of a battery of a comparative example as seen from above in the stacking direction of the electrode stack (top side), and a schematic plan view as an example of a battery of the comparative example as seen from below in the stacking direction of the electrode stack (bottom side).

### DESCRIPTION OF EMBODIMENTS

An embodiment of the disclosure will now be described in detail with reference to the accompanying drawings. The disclosure is not limited to the embodiment described below, however, and various modifications may be implemented which do not depart from the gist thereof. The dimensional relationships in the drawings do not reflect actual dimensional relationships.

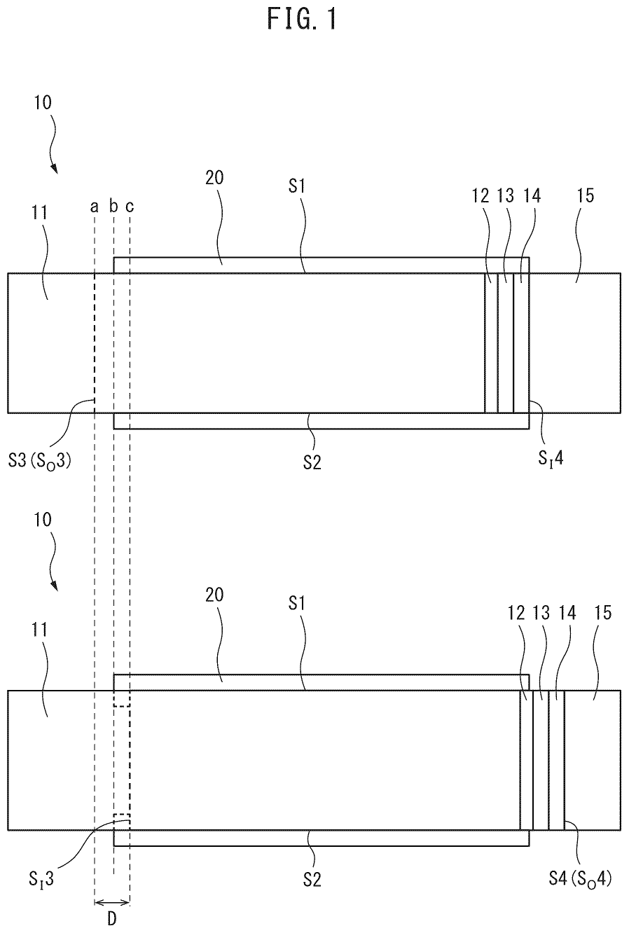

The examples shown in FIGS. 1 to 5 have the electrode stack 10 formed of two preliminary electrode stacks 10′, but the number of preliminary electrode stacks 10′ is not limited to two.

### <Electrode Stack>

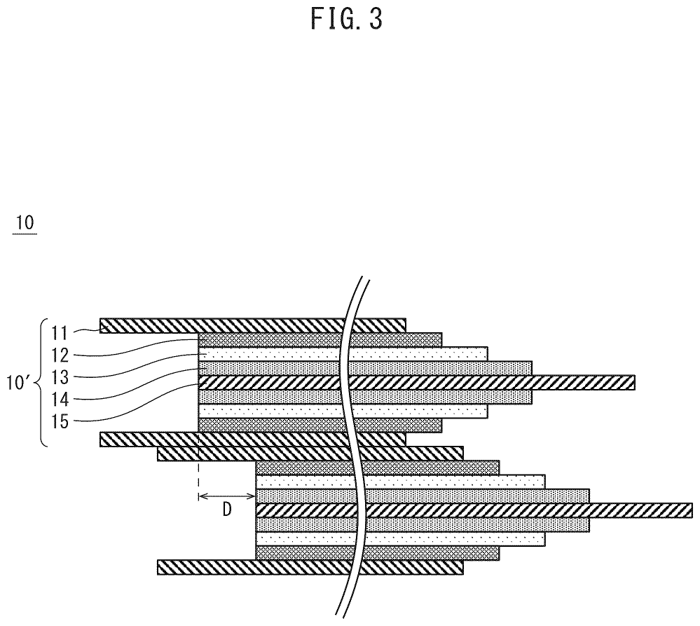

As exemplified in FIG. 1, the electrode stack 10 of the disclosure comprises a first side section (S1) where a protective member 20 including a curable resin is disposed and a second side (S2) section opposite the first side section, and a third side section (S3) and a fourth side section (S4) opposite the third side section, and its shape is rectangular. As exemplified in FIG. 3, the electrode stack 10 of the disclosure is formed by stacking a plurality of preliminary electrode stacks 10′. In the electrode stack 10 of the disclosure, the locations of the third and/or fourth side sections (S3, S4) of the plurality of preliminary electrode stacks 10′ do not mutually match in the in-plane direction of the electrode stack 10, (i) the protective member 20 extends at least partway between the third side section (S_{I}3) of the innermost preliminary electrode stack 10′ and the third side section (S_{O}3) of the outermost preliminary electrode stack 10′, and/or (ii) the protective member 20 extends at least partway between the fourth side section (S_{I}4) of the innermost preliminary electrode stack 10′ and the fourth side section (S_{O}4) of the outermost preliminary electrode stack 10′.

As mentioned above, a protective member 20 including a curable resin may peel from the electrode stack 10, resulting in a failure to adequately exhibit its function as a protective member 20.

In this regard, the present inventors focused on the fact that in an electrode stack 10 formed from a plurality of preliminary electrode stacks 10′, each preliminary electrode stack 10′ is produces shifting in the in-plane direction, and the present disclosure was developed on this basis. Specifically, it was found that if a protective member 20 extends at least partway between the third and/or fourth side sections of the innermost preliminary electrode stack 10′ and the third and/or fourth side sections of the outermost preliminary electrode stack 10′, then peeling of the protective member 20 from the electrode stack 10 is effectively inhibited.

This is thought to occur because wrapping the protective member 20 around up to the third and/or fourth side sections of any desired preliminary electrode stack 10′ other than the outermost preliminary electrode stack 10′, results in more firm anchoring to the electrode stack 10.

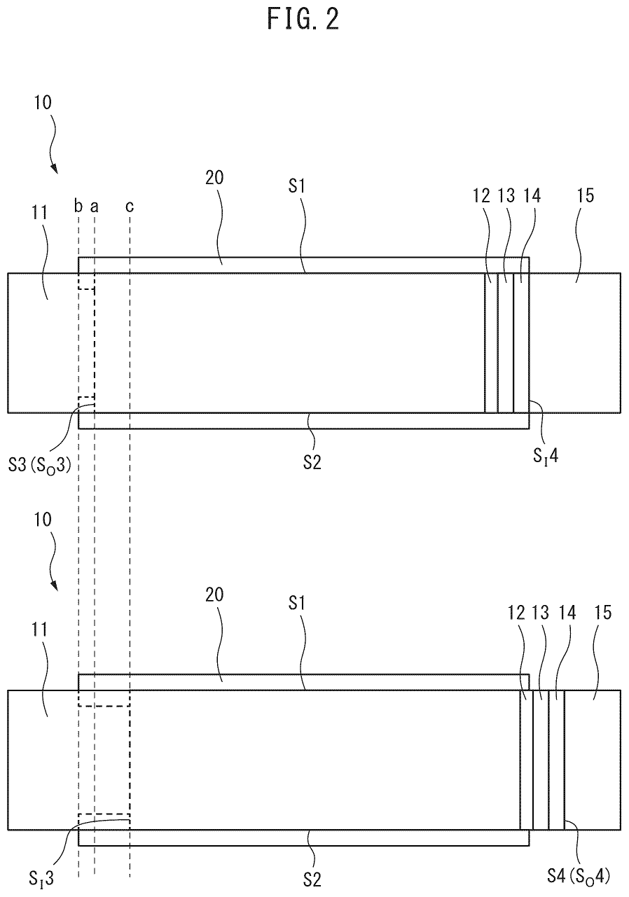

FIGS. 1 to 5 show examples where the electrode stack 10 is composed of two preliminary electrode stacks 10′. In these drawings, the side section of the electrode stack on the side where the positive electrode collector terminal 31 is disposed is the third side section (S3), and the side section of the electrode stack on the side where the negative electrode collector terminal 32 is disposed is the fourth side section (S4), for convenience. The third side section (S3) is shown at the edges of the positive electrode collector terminal 31 sides of the negative electrode collector layer 15, negative electrode active material layer 14, electrolyte layer 13 and positive electrode active material layer 12. FIGS. 1 to 5 show examples where the positive electrode active material layer 12 is formed smaller than the negative electrode active material layer 14, and therefore the locations of each of the layers of the electrode stack 10 in the in-plane direction do not match on the fourth side section (S4) side. In FIG. 1 and FIG. 2, therefore, the fourth side section (S4) is shown at the edges of the negative electrode collector terminal 32 side of the negative electrode active material layer 14. The fourth side section (S4) may also be the edge of another layer forming the electrode stack 10, such as the edge of the positive electrode collector layer 11. The size of the positive electrode active material layer 12 may also be equal to the size of the negative electrode active material layer 14, and therefore the locations of each of the layers in the in-plane direction forming the electrode stack 10 may match at the fourth side section (S4) as well, similar to the third side section (S3).

In FIGS. 1 and 2 and FIGS. 4 and 5, the dashed lines a, b and c are imaginary lines representing positional relationships with respect to the third side section (S_{O}3) in the in-plane direction. Specifically, the dashed line “a” represents the location of the outermost preliminary electrode stack 10′ in the in-plane direction of the third side section (S_{O}3), the dashed line “b” represents the location of the preliminary electrode stack in the in-plane direction of the protective member extended up to the third side section (S_{I}3), and the dashed line “c” represents the location of the innermost preliminary electrode stack 10′ in the in-plane direction of the third side section (S₁3).

In other words, the dashed line “a” represents the in-plane location of the side section nearest to the positive electrode collector terminal 31, among the side sections of the preliminary electrode stack 10′ on which the positive electrode collector terminal 31 is disposed, the dashed line “b” represents the in-plane location of the protective member 20 extended up to the side section of the preliminary electrode stack 10′ where the positive electrode collector terminal 31 is disposed, and the dashed line “c” represents the in-plane location of the side section furthest from the positive electrode collector terminal 31, among the side sections of the preliminary electrode stack 10′ where the positive electrode collector terminal 31 is disposed.

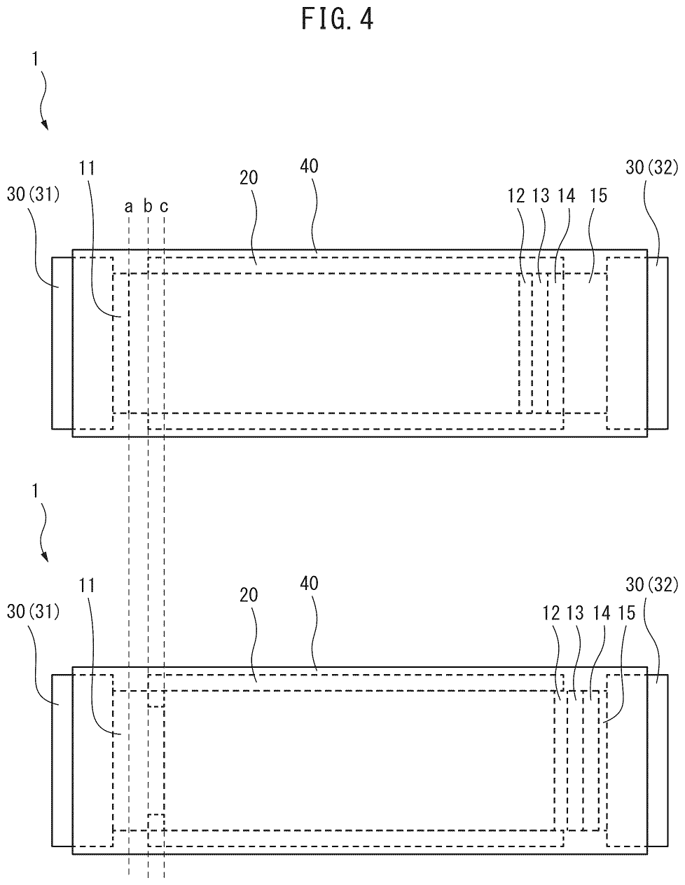

In the electrode stack 10 of the disclosure and battery 1, as exemplified in FIGS. 1 and 4, the dashed lines are aligned in the order “a”, “b” and “c” from the positive electrode collector terminal 31 side. That is, the in-plane location “a” at the nearest side section from the positive electrode collector terminal 31 among the side sections of the preliminary electrode stack 10′ on which the positive electrode collector terminal 31 is disposed, is further toward the positive electrode collector terminal 31 side than the in-plane location “b” of the protective member 20 which is extended up to the side section of the preliminary electrode stack 10′ on which the positive electrode collector terminal 31 is disposed.

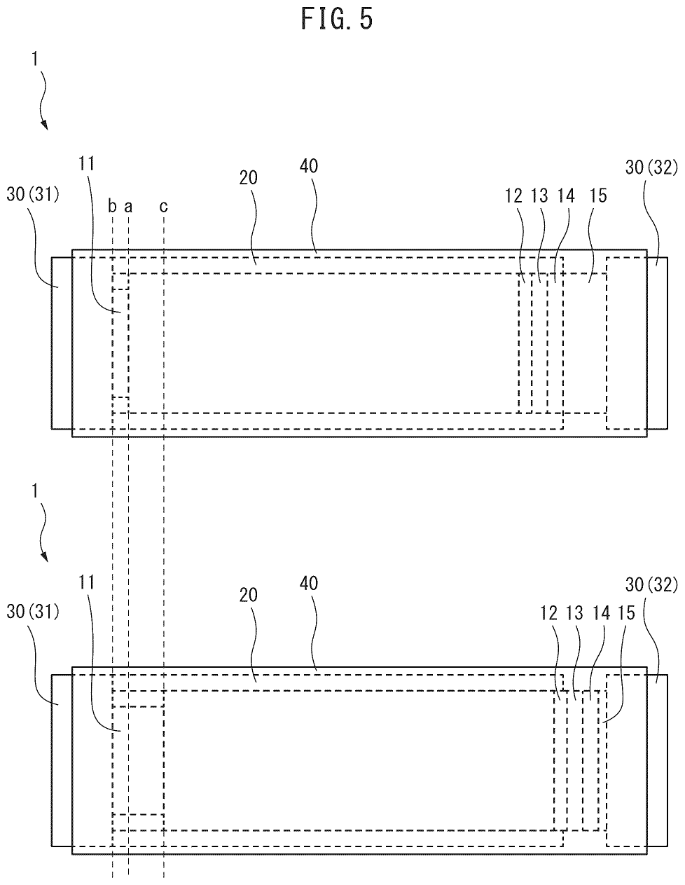

In an electrode stack 10 and battery 1 according to the Comparative Examples, on the other hand, as exemplified in FIGS. 2 and 5, the dashed lines are aligned in the order “b”, “a” and “c” from the end side on which the positive electrode collector terminal 31 is disposed. That is, the in-plane location “b” of the protective member 20 which is extended up to the side section of the preliminary electrode stack 10′ on which the collector terminal 31 is disposed, is further toward the positive electrode collector terminal 31 side than the in-plane location at the nearest side section from the positive electrode collector terminal 31 among the side sections of the preliminary electrode stack 10′ on which the positive electrode collector terminal 31 is disposed.

An electrode stack according to the Comparative Examples exemplified in FIGS. 2 and 5 may also be expected to exhibit an effect of inhibiting peeling of the protective member from the electrode stack. However, as mentioned above, a battery fabricated to comprise this type of electrode stack introduces the problem of interference between the collector terminals and protective member.

The present inventors developed this disclosure upon finding that by using an electrode stack and battery as exemplified in FIGS. 1 and 4, it is possible to inhibit peeling of the protective member from the electrode stack while reducing interference between the collector terminals and protective member.

In the electrode stack 10 of the disclosure, the locations of the third and/or fourth side sections of the plurality of preliminary electrode stacks 10′ do not mutually match in the in-plane direction of the electrode stack 10. That is, when the electrode stack 10 is viewed from the side, from the side section on which the protective member is disposed, each preliminary electrode stack 10′ is shifted in the in-plane direction.

In the electrode stack 10 of the disclosure, (i) the protective member 20 extends at least partway between the third side section (Sᵢ3) of the innermost preliminary electrode stack 10′ and the third side section (Sₒ3) of the outermost preliminary electrode stack 10′, and/or (ii) the protective member 20 extends at least partway between the fourth side section (S_{I}4) of the innermost preliminary electrode stack 10′ and the fourth side section (Sₒ4) of the outermost preliminary electrode stack 10′.

That is, in regard to (i) with the electrode stack 10 as exemplified in FIG. 1, the protective member 20 does not extend on the third side section (Sₒ3) of the preliminary electrode stack 10′ on the top side, but instead the protective member 20 extends to the third side section (Sᵢ3) of the preliminary electrode stack 10′ on the bottom side.

FIG. 1 shows a state where the protective member 20 is only provided up to the part matching with the in-plane location of the fourth side section (Sᵢ4) of the innermost preliminary electrode stack 10′, but the protective member 20 may also be extended at least partway between the fourth side section (Sᵢ4) of the innermost preliminary electrode stack 10′ and the fourth side section (Sₒ4) of the outermost preliminary electrode stack 10′, similar to the side of the third side section. This will allow the aspect according to (ii) to be provided.

In the electrode stack 10 of the disclosure, the protective member 20 may extend only partway between the third side section (Sᵢ3) of the innermost preliminary electrode stack 10′ and the third side section (Sₒ3) of the outermost preliminary electrode stack 10′, and/or the protective member 20 may extend only partway between the fourth side section (Sᵢ4) of the innermost preliminary electrode stack 10′ and the fourth side section (Sₒ4) of the outermost preliminary electrode stack 10′. With this type of construction it is possible to reduce production cost compared to when the protective member is disposed over the entire third and/or fourth side sections, for example.

When the electrode stack is formed of 3 or more preliminary electrode stacks, the protective member may extend up to the third and/or fourth side sections of any desired preliminary electrode stack other than the outermost preliminary electrode stack.

The distance D between the third side section (Sᵢ3) of the innermost preliminary electrode stack and the third side section (Sₒ3) of the outermost preliminary electrode stack may be 0.5 mm or more and 2.0 mm or less, and/or the distance D between the fourth side section (Sᵢ4) of the innermost preliminary electrode stack and the fourth side section (Sₒ4) of the outermost preliminary electrode stack may be 0.5 mm or more and 2.0 mm or less. The distance D may be 0.5 mm or more, 0.6 mm or more, 0.7 mm or more, 0.8 mm or more, 0.9 mm or more or 1.0 mm or more, and 2.0 mm or less, 1.8 mm or less, 1.6 mm or less, 1.4 mm or less, 1.2 mm or less or 1.0 mm or less. If the distance D is within this range, then it will be easier to dispose the protective member at the desired location, and to thus effectively inhibit peeling of the protective member from the electrode stack. The distance D may be the shortest distance between the third side section (Sᵢ3) of the innermost preliminary electrode stack and an imaginary plane extending the third side section (Sₒ3) of the outermost preliminary electrode stack in the vertical direction, or the shortest distance between the fourth side section (Sᵢ4) of the innermost preliminary electrode stack and an imaginary plane extending the fourth side section (Sₒ4) of the outermost preliminary electrode stack in the vertical direction.

The construction of the electrode stack of the disclosure will now be described.

As exemplified in FIG. 1, the electrode stack 10 of the disclosure comprises a first side section (S1) on which a protective member 20 including a curable resin is disposed and a second side (S2) section opposite the first side section, as well as a third side section (S3) and a fourth side section (S4) opposite the third side section, and its shape is rectangular.

As exemplified in FIG. 3, the electrode stack 10 is formed by stacking a plurality of preliminary electrode stacks 10′. The electrode stack 10 may have a positive electrode collector layer 11, positive electrode active material layer 12, electrolyte layer (separator layer) 13, negative electrode active material layer 14 and negative electrode collector layer 15, in that order.

The term “preliminary electrode stack” as used herein means a stack having the negative electrode active material layer 14, electrolyte layer 13, positive electrode active material layer 12 and positive electrode collector layer 11 in that order on both sides of the negative electrode collector layer 15. In other words, a preliminary electrode stack is a stack having a positive electrode collector layer, positive electrode active material layer, electrolyte layer, negative electrode active material layer, negative electrode collector layer, negative electrode active material layer, electrolyte layer, positive electrode active material layer and positive electrode collector layer, in that order. The term “electrode stack” refers to a stack formed by stacking positive electrode collector layers 11 of the plurality of preliminary electrode stacks 10′ in contact with each other, or a stack formed by stacking a positive electrode collector layer 10 which is shared between preliminary electrode stacks 10′.

The preliminary electrode stack may also have other layers than those mentioned above. For example, it may have a carbon layer between the positive electrode collector layer and the positive electrode active material layer.

If the shapes of each of the parts of the layers forming the electrode stack in the in-plane direction are rectangular, then it will be possible to form a rectangular electrode stack. The shapes of the parts of the positive electrode collector layer and negative electrode collector layer of the electrode stack extending from the side sections are not particularly restricted, and any appropriate design may be employed in consideration of facilitating attachment with the collector terminals as described below.

### <Method for Producing Electrode Stack>

The method of the disclosure for producing an electrode stack comprises the following steps: stacking a plurality of preliminary electrode stacks to form an electrode stack so that the locations of the third and/or fourth side sections do not mutually match in the in-plane direction, coating the first and second side sections of the electrode stack with a curable resin so that the end of the curable resin on the side of the third side section is located between the third side section of the innermost preliminary electrode stack and the third side section of the outermost preliminary electrode stack, and curing the curable resin to provide a protective member, and/or: coating the first and second side sections of the electrode stack with a curable resin so that the end of the curable resin on the side of the fourth side section is located between the fourth side section of the innermost preliminary electrode stack and the fourth side section of the outermost preliminary electrode stack, and curing the curable resin to provide a protective member.

With this method, the curable resin can permeate up to the third and/or fourth side sections of any desired preliminary electrode stack other than the outermost preliminary electrode stack, and subsequent curing allows the protective member to be provided on the desired location to obtain an electrode stack of the disclosure.

In order for the protective member to be disposed more reliably on the third and/or fourth side sections of any desired preliminary electrode stack other than the outermost preliminary electrode stack, the curable resin may be coated and cured directly on the third and/or fourth side sections of the desired preliminary electrode stack.

### <Battery>

FIG. 4 shows a schematic plan view as an example of a battery of the disclosure as seen from above in the stacking direction of the electrode stack (top side), and a schematic plan view as an example of a battery of the disclosure as seen from below in the stacking direction of the electrode stack (bottom side). As exemplified in FIG. 4, the battery 1 of the disclosure comprises an electrode stack 10 of the disclosure, collector terminals 30 disposed on the third and fourth side sections of the electrode stack, and a laminate film 40 sealing the electrode stack 10 together with the collector terminals 30.

FIG. 5 shows a schematic plan view as an example of a battery of a comparative example of the disclosure as seen from above in the stacking direction of the electrode stack (top side), and a schematic plan view as an example of a battery of the comparative example of the disclosure as seen from below in the stacking direction of the electrode stack (bottom side). When the protective member 20 is extended up to the side sections of the outermost preliminary electrode stack where the collector terminals 30 are disposed, in order to more firmly anchor the electrode stack 10 and protective member 20, the collector terminals 30 and protective member 20 may mutually interfere, as exemplified above and below in FIG. 5. In order to help reduce such interference it is necessary to provide excess space between the collector terminals 30 and protective member 20, but this then lowers the structural efficiency of the battery.

In this regard, the present inventors found that the problem can be solved by a battery having an electrode stack according to the disclosure.

This is thought to be because in the electrode stack 10 of the disclosure, the protective member 20 is disposed further inward than the side section of the outermost preliminary electrode stack 10′, i.e. of the preliminary electrode stack 10′ located furthest from the collector terminal 30, on which the collector terminal 30 is disposed, so that the collector terminal 30 and protective member 20 do not interfere and consequently the battery does not require excess space between the collector terminal 30 and protective member 20.

The elements composing the battery of the disclosure will now be described.

### <Electrode Stack>

The electrode stack may be understood by referring to the aforementioned description of the electrode stack of the disclosure.

### <Protective Member>

The protective member 20 is disposed on the first side section of the electrode stack 10 and the second side section opposite the first side section.

The protective member includes a curable resin. The curable resin is not particularly restricted and may be, for example, a photocuring resin such as a UV curing resin or electron beam-curing resin, or a thermosetting resin. A curable resin may be a radical-polymerizing resin or a cationic polymerizable resin, or a combination thereof.

### <Collector Terminal>

The collector terminal 30 is disposed on the third side section of the electrode stack 10 and the fourth side section opposite the third side section. The collector terminal is electrically connected to the electrode stack by a current collector that extends from the third and fourth side sections of the electrode stack. The current collector may be a bundle of sections of the positive electrode collector layers of the electrode stack where the other layers are not laminated, or it may be a bundle of sections of the negative electrode collector layers of the electrode stack where the other layers are not laminated.

The material of the collector terminal is not particularly restricted so long as it is a material with a current collection function, and for example, it may be the same metal material as the positive electrode collector layer and negative electrode collector layer.

The shape and size of the collector terminal are not particularly restricted, so long as the electrode stack can be sealed together with the laminate film.

### <Laminate Film>

The laminate film 40 seals the electrode stack 10, together with the collector terminals 30. Specifically, the laminate film 40 may seal the electrode stack 10 together with the collector terminals 30 by winding together the electrode stack 10 and the collector terminals 30. The laminate film 40 may also be constructed of first and second films, in which case the first and second films may seal the electrode stack 10 together with the collector terminals 30, sandwiching above the electrode stack 10 and the collector terminals 30 from above and below in the stacking direction of the electrode stack 10. The laminate film may have a fusion layer, a metal layer and a resin layer, in that order along the thickness direction.

### <Remaining Construction>

The battery of the disclosure may also comprise members other than those mentioned above.

For example, an insulating resin may be disposed on the side section on which the positive electrode collector terminal is disposed.

### EXAMPLES

### Example 1

### <Fabrication of Electrode Stack>

Two preliminary electrode stacks were prepared in such a manner that the locations of the side sections on which the collector terminals were disposed did not mutually match in the in-plane direction. An electrode stack was thus obtained as shown in FIG. 3.

### <Coating of Curable Resin>

A dispenser was used to apply a UV curing resin onto the side sections on which the collector terminals of the electrode stack were not disposed, in such a manner that the end of the curable resin at the side section on which the positive electrode collector terminal was disposed was located between the side section of the innermost preliminary electrode stack and the side section of the outermost preliminary electrode stack.

### <Placement of Protective Member>

A protective member was disposed by irradiating the coated resin with ultraviolet rays to cure the resin. An electrode stack for Example 1 was thus obtained, as shown in FIG. 1.

### <Fabrication of Battery>

Collector terminals were disposed on the side sections of the obtained electrode stack on which the protective member was not disposed, and the electrode stack was sealed together with the collector terminals using a laminate film. A battery for Example 1 was thus obtained, as shown in FIG. 4.

### <Evaluation>

### <Resistance to Peeling of Protective Member>

The protective member disposed on the electrode stack was evaluated for resistance of the protective member to peeling, based on the tensile stress acting when pulling from the end on the side section on which the positive electrode collector terminal was disposed. Specifically, the evaluation was “VG” when the tensile stress was >200 N, “G” when the tensile stress was >50 N and <200 N, and “P” when the tensile stress was <50 N.

### <Interference Between Collector Terminals and Protective Member>

The presence or absence of interference between the collector terminals and protective member in the battery was evaluated. Specifically, the evaluation was “No” when there was no contact of the collector terminals with the protective member disposed on the electrode stack nearest the collector terminals, and “Yes” when there was contact with the protective member.

### Comparative Example 1

An electrode stack and battery for Comparative Example 1 as shown in FIGS. 2 and 5 were fabricated and evaluated in the same manner as Example 1, except that in the curable resin coating step, the curable resin was coated up to the side section of the outermost preliminary electrode stack where the positive electrode collector terminal was disposed.

### Comparative Example 2

An electrode stack and battery for Comparative Example 2 were fabricated and evaluated in the same manner as Example 1, except that in the curable resin coating step, the curable resin was coated further toward the inner side of the innermost preliminary electrode stack, than the side section on which the positive electrode collector terminal was disposed, i.e. no curable resin was coated on the side section of any preliminary electrode stack where the positive electrode collector terminal was disposed.

### <Results>

Table 1 shows evaluation results for resistance to peeling of the protective member, and interference between the collector terminals and protective member.

TABLE 1

| | Resistance to | Interference between |
|---|---|---|
| | peeling of | collector terminals |
| | protective | and protective |
| | member | member |
| Example 1 | G | No |
| Comparative Example 1 | VG | Yes |
| Comparative Example 2 | P | No |

As seen in Table 1, with the electrode stacks of the Examples it was possible to adequately inhibit peeling of the protective member, while no interference between the collector terminals and protective member was exhibited with the batteries of the Examples.

### REFERENCE SIGNS LIST

1 Battery
10 Electrode stack
10′ Preliminary electrode stack
11 Positive electrode collector layer
12 Positive electrode active material layer
13 Electrolyte layer
14 Negative electrode active material layer
15 Negative electrode collector layer
20 Protective member
30 Collector terminal
31 Positive electrode collector terminal
32 Negative electrode collector terminal
40 Laminate film

1. An electrode stack which is rectangular and comprises a first side section where a protective member including a curable resin is disposed and a second side section opposite the first side section, and a third side section and a fourth side section opposite the third side section,
wherein the electrode stack is formed by stacking a plurality of preliminary electrode stacks,
wherein the locations of the third and/or fourth side sections of the plurality of preliminary electrode stacks do not mutually match in the in-plane direction of the electrode stacks,
wherein (i) the protective member extends at least partway between the third side section of the innermost preliminary electrode stack and the third side section of the outermost preliminary electrode stack, and/or
wherein (ii) the protective member extends at least partway between the fourth side section of the innermost preliminary electrode stack and the fourth side section of the outermost preliminary electrode stack.

2. The electrode stack according to claim 1, wherein:
the protective member extends only partway between the third side section of the innermost preliminary electrode stack and the third side section of the outermost preliminary electrode stack, and/or,
the protective member extends only partway between the fourth side section of the innermost preliminary electrode stack and the fourth side section of the outermost preliminary electrode stack.

3. The electrode stack according to claim 1, wherein:
the distance between the third side section of the innermost preliminary electrode stack and the third side section of the outermost preliminary electrode stack is 0.5 mm or more and 2.0 mm or less, and/or,
the distance between the fourth side section of the innermost preliminary electrode stack and the fourth side section of the outermost preliminary electrode stack is 0.5 mm or more and 2.0 mm or less.

4. A battery comprising:
an electrode stack according to claim 1,
collector terminals disposed on the third and fourth side sections of the electrode stack, and
a laminate film sealing the electrode stack together with the collector terminals.
